(19) United States
(12) Patent Application Publication
(10) Pub. No.: US 2015/0142477 A1
(43) Pub. Date: May 21, 2015

(54) SYSTEM AND METHOD FOR MANAGING VARIATIONS IN PROJECT PROJECTIONS

(71) Applicant: THE TRIMOUNTAINE GROUP, LLC, Salem, MA (US)

(72) Inventors: Richard Paul Schuster, Salem, MA (US); Donald J. Riggin, Salem, MA (US)

(73) Assignee: THE TRIMOUNTAINE GROUP, LLC, Salem, MA (US)

(21) Appl. No.: 14/085,063

(22) Filed: Nov. 20, 2013

(51) Int. Cl. G06Q 40/08

(52) U.S. Cl. CPC G06Q 40/08
USPC 705/4

(57) ABSTRACT

An insurance product provides coverage for value escalation in a highly capitalized project. One or more indices are used to obtain a quantification of volatility of the value of the project over the project lifecycle. Probabilities of value changes over the project lifecycle can be generated from an index, which can be solely representative of the project value, or can be the result of combinations of one or more indices to approximate project value changes. The project value change probabilities are used to estimate an amount of insurance coverage that can be applied to cover project value changes. The party responsible for the project can purchase the insurance product with a premium derived from the amount and type of coverage tied to the index. The insurance product assists the responsible party in containing changes in project value over the course of the project life cycle.

### STATEMENT REGARDING FEDERALLY SPONSORED RESEARCH OR DEVELOPMENT

(Not Applicable)

### BACKGROUND OF THE INVENTION

Large, capitally intensive construction projects are typically exposed to a number of challenges related to variations in value of project components over the course of the project life cycle. Project components refer to various resources used in the completion of the project. Some examples include labor, materials, financing, design, engineering, vendor/contractor performance, permitting, environmental compliance and any other component of a project that influences project conception, progress and/or completion. As used herein, the term “project component” is meant to refer to such resources individually or in combination or to an overall project or project components collectively. The value of a given project component can refer to a measure of the worth of the project component in the overall project. The value of a project component can be assigned in accordance with a number of different paradigms, including such typical examples as price, time, deliverables, performance or any other kind of measure of project component worth.

Variations in the value of project components (or projects) can be significant over the course of the overall project. For example, a project with a timeframe of five years may depend upon the purchase of a given material in large quantities over the course of the project. The prices for the material may increase or decrease significantly at the various times of purchase over the course of the project. It is often difficult to completely quantify project component cost and scheduling at the outset of or even during the project. The often unpredictable variations in the value of project components can typically affect the ability of the project to meet desired goals. One goal of project owners or project managers or a responsible party involved in delivering project components (individually or collectively “project sponsor”) is to control the variations in project component value so as to meet desired budgetary, schedule or performance goals. However, certain variations in the value of project components are outside of the control of the project sponsor. These variations in values for project components typically exists on a “macro” level, meaning that they are derived from forces that are typically present in a global context. For example, the variations may find sources in weather patterns across the globe, geo-political instability, price variation on materials, transportation or labor costs, as examples. In general, the execution of a given project does not affect these macro level variations. Accordingly, project sponsors are left to attempt to predict the amount of variation in the value over the timeframe of a project.

As used herein, variation refers to changes in the value of a given project component over time. As an example, a project planner may estimate a linear change in cost of a given material over the course of a project component that uses the material. The project sponsor would then use this estimate of price variation to project the estimated cost of the material when purchased at certain future points during the project component lifecycle.

The value of a project component is also subject to volatility, which represents a measure of how fast or how much the value differs from the estimated change in value, e.g. the variation of the project component value discussed above. Volatility is typically measured by how much or how fast the value changes over a given period of time.

Large scale projects tend to be relatively sensitive to value variations and volatility among the various components of the project, and are particularly sensitive to price inflation. Such large scale projects typically have a fairly long lead time due to the various stages involved in project planning, including design, development, engineering, finance and construction stages. As the costs of the project increases due to price inflation, the economic benefits of the project can be substantially eroded. Accordingly, the project sponsor is challenged with the management of the value of a large scale project or project component that varies from their estimated value in ways that are beyond the control of the project sponsor. In particular, the volatility of the variations in value of project components tends to be resistant to being easily quantified or controlled by a project sponsor.

Traditionally, a project sponsor would obtain or provide a value estimate for a project component that would include provisions for some degree of variation in value. The provisions might include an estimate that would typically have a built-in buffer to protect against variation and volatility of the component value over the course of the project execution. If a project component value exceeded the estimate, the excess value was typically covered through a reserved contingency in the project budget. Such an approach can be somewhat effective, as long as the volatility of the component value is low, since the projected value of the project component could be forecasted over the course of the project with some degree of accuracy. Often, the buffer amount that is built into the estimate for the project component over the course of the project could be borne by any of the participants in a project by agreement.

If the variation in the value of the project component becomes increasingly volatile, especially over the course of the project, the estimate for the total project component value, including a buffer value, becomes increasingly inaccurate. Volatility of the value of the project component can lead to significant price fluctuation for the overall project, especially over the term of a large scale project.

As an example, steel is often a component of large scale projects, the price of which can sometimes vary widely. Throughout the 1990's, steel prices increased at an annual rate that was fairly regular and predictable. The volatility on the price increase of steel on an annual rate was relatively low, so that maximum price variations could be estimated with a certain amount of reliability to provide a fairly robust estimate for cost increases over the course of a large scale project that may have a time frame of six months to several years. However, in the 2000's, the price of steel began to fluctuate significantly, and increased by a greater percentage than previously observed. In addition, the volatility of the price of steel increased significantly. If the price of steel had escalated in a regular fashion without the corresponding increase in volatility, fairly reliable estimates could still be produced for large scale projects. However, introduction of the increased volatility to the price of steel created greater uncertainty for the estimated costs of steel at given points over the duration of a large scale project. The price of steel at the time of purchase at various points over the project timeframe were of particular concern due to their unpredicability.

Other issues may combine to affect steel costs indirectly, such as the costs of transportation, labor, fuel, storage or other factors relevant to processing and installation of steel components. For example, if a project sponsor observes a potential opportunity for purchasing steel at a reduced price, the factors of transportation, labor, storage or other relevant project components may contribute to a decision that avoids capitalizing on the opportunity.

A number of methodologies have been proposed to attempt to control and manage the fluctuations in project component values and their anticipated escalation of value. Some of the methodologies seek to transfer, allocate or share the uncertainty related to the variation of the component value among the various entities involved in the project. For example, a contract between a project manager and a supplier may include escalation terms that effectively put the burden of the project component value variations on the project manager. In such an instance, the project manager becomes responsible for payment of additional costs related to variations in the project component value.

Alternatively, the vendor may take responsibility for cost escalation and provide allowances to cover value variations in a bid submitted for the project component. In such an instance, the contract price may be inflated to protect against potential volatility. Another option is for the vendor to present the project manager with a fixed price contract that includes increases to the project contingency funding or the project manager's reserve to act as a buffer for accommodating variations in the project component value. In such prior situations, surety bonds were typically used to leverage vendor performance to control and manage default situations. However, surety bonds are typically structured to use liquid damages as leverage against non-performance, which can be inefficient when used to attempt to control project component value variations. For example, the vendor may face major challenges such as bankruptcy or labor strikes, which would prompt liquid damages provisions, but still leave the project manager without performance. The project manager would thus have no practical means for controlling and managing project component value variations, including price escalation volatility even with a surety bond in place. In addition, unquantified volatility can lead the vendor to submit excessively high bids to cover exigencies, which may cause loss of business for the vendor or project manager.

Some capital market instruments or derivatives can be used to help offset changes in the expected values for project components due to volatility. For example, options, swaps, forward contracts, futures and other like derivatives are typically available in various commodity markets. However, some project components often do not have a particular market, such as the commodity markets, to help offset variations in value. Some typical examples include labor costs and performance time (delay) values. In addition, the commodity market derivatives do not provide offsets for the value variations of an entire project, especially since the various project components are not heterogeneous to the underlying assets. Moreover, project components are not typically composed of raw materials with cost variations that might be offset using derivatives in a commodity market. Rather, project components are typically processed materials or complex pieces of equipment, such as transformers, motors or turbines, for which no secondary or derivative market exists.

At present, no known methodology is available to cohesively manage value escalation and volatility, or provide a way for the variations and volatility to be constrained and/or transferred among entities involved in large scale projects in a quantifiable way. Furthermore, although it is known that insurance entities are sometimes willing to insure against value escalation and/or volatility, there is no mechanism by which the escalation or volatility can be easily quantified to satisfy the needs of an insurance entity that might underwrite coverage for such events.

An example of the problem can be provided with respect to the costs of line pipe steel as used in the construction of a three billion dollar pipeline project that is implemented over a number of years. If the project manager were to try to account for variations and volatility in the costs of line pipe steel over the course of the project, they may contract to absorb the costs of variation and volatility by maintaining a reserve or contingency in the project budget. Alternately, or in addition, the project manager may choose to have the vendor of the line pipe steel absorb the costs of the variation and volatility in the costs of the line pipe steel. In such a three billion dollar pipeline project, the cost of the reserve or contingency budget, or the additional amount charged by the vendor to cover the variation and volatility in the line pipe steel, may amount to 20-300 of the entire project budget. This percentage can be typical of a lump sum turnkey (LSTK) bid used by a vendor or EPC (engineering, procurement and construction) contractor, and can still be highly inaccurate due to price volatility of steel. For example, according to some estimates, some 40% of projects overrun their budgets, and suffer from performance issues and scheduled delays, even when escalation costs and contingency buffers are estimated with a broad range of change.

### BRIEF SUMMARY OF THE INVENTION

In accordance with the present disclosure, systems and methods are provided to quantify variations and volatility in a project component in accordance with an index. The index is used to estimate value escalation of the project component over its life cycle. The value escalation estimate can then be used to obtain insurance coverage for the quantified variation and volatility of the project component, corresponding to a premium payment.

According to an aspect, one or more indexes may be used, combined or generated to obtain a synthetic index that estimates the variation and volatility of the underlying project component. The synthetic index is used to generate a forecast of escalation values for the project component over certain periods of time relevant to the project time frame. The probabilities of the escalation values changing beyond a certain percentage, based on the index quantified variation and volatility, are used to generate a range of potential costs and probabilities related to variations and volatility in escalation costs.

According to another aspect, the estimated costs and associated probabilities derived from an index can be used in creating an insurance product with a premium that reflects the desired coverage for a predetermined set of costs and associated probabilities. The project sponsor can assess how much coverage they wish to obtain for a given set of costs and associated probabilities, to thereby manage the variation and volatility of escalation costs for a project component. The cost of the premium for the insurance product, combined with retention and limit costs absorbed by the insured is expected to be significantly less than the amount that would otherwise be paid in an LSTK EPC contract.

According to an aspect of the disclosure, an index is identified for estimating volatility of the value of a project component based on how closely the index tracks with the value of the project component and a history of the index. The index history is assessed to ensure that an amount of historical data is available that is comparable with a period of time for the life cycle of the project component. For example, for a project component that has a six month expected life cycle, several decades of data may be preferred to implement an aspect of the systems and methods of the present disclosure.

A project component might be associated with a number of different indices, each of which may have its own periodicity for reporting data in historical records. In such an instance, a synthetic index, or combination of indices can be generated that accommodates the different data reporting intervals and available historical data to obtain an index that provides sufficient historical data with sufficient intervals of data reporting for the purposes of the present disclosure. For example, a monthly reporting index can be combined with a yearly reporting index to produce an artificial index that is populated with data on a yearly interval. As long as the amount of historical data is sufficient to permit analysis and implementation in accordance with the present disclosure, the periodicity for such an artificial index can be chosen to be the longest of the underlying indices. In addition, or alternately, an artificial index can be created by making estimates or interpolations of the underlying index with the larger interval of data reporting of the underlying indices. In general, the periodicity of the index is chosen to ensure that volatility measures of all the underlying indices are preserved.

The indices from which a desired index may be selected or generated are intended to capture at least some historic value variation and/or volatility of a project component. Accordingly, estimates for some or all of the project component escalation values, or for those of the overall project, can be quantified in accordance with the present disclosure.

According to another aspect of the present disclosure, the indices or index used to represent value escalation for a project component or for the overall project are evaluated to obtain a probability distribution of volatility. For example, a histogram for the value of a project component can be developed based on index information, so that probabilities of variations and volatility in the value of the project component can be evaluated. The histogram is used, for example, to represent the probabilities that escalations or variations in the value of the project component will change over the course of the project component life cycle. The change in the variation of the value of the project component, or the volatility associated with that value, which volatility can be expressed in terms of probability in accordance with the information provided by the histogram.

According to another aspect of the present disclosure, a probability distribution for volatility in the variation of project component value is evaluated to determine a probability of percentage change. For example, a histogram is used to estimate the probability that the value of the project component during the life cycle of the project component will change by a given percentage. According to a particular case, the probability that the value will change from the expected value can be measured from a median value of the probability distribution. For example, the probability that the value of the project component will change from a median estimated escalation value can be determined for a range of probabilities above and below the median estimated escalation value. The range of probabilities can be used as a quantifiable set of data upon which a project owner or manager can make a judgment as to how much escalation in the value of the project component they are willing to cover, or have be covered, such as by using insurance coverage.

According to another aspect of the present disclosure, a quantifiable amount of volatility in the value of a project component can be used as the basis for an insurance policy that can be written to provide coverage for value volatility within a range of probabilities. The insurance policy can provide coverage between a retention amount that the project owner or manager wishes to reserve to themselves, and a limit of coverage that defines where the insurance provider responsibility for coverage ends. The range of coverage between the retention amount and the limit amount is associated with a premium that is paid by the project sponsor associated with the project. The project sponsor, as the insured party is thus provided with coverage for protection against project component value volatility over the course of the project component life cycle.

According to this aspect of the disclosure, various types of insurance policies can be generated and applied to meet the specific requirements of the project component. For example, an insurance policy that provides for repayment of a portion of the premium to the insured if none or a percentage of covered losses is experienced by the insured. Insurance policies can also be provided that have graduated premiums that can be adjusted to reflect actual conditions of the value of the project component over a number of periods of the project component life cycle.

According to another aspect of the present disclosure, combinations of indices can be generated to obtain synthetic indices for a portion or all of a project component, one or more combinations of project components or portions thereof, entire projects, or portions thereof, as well as combinations of projects or portions thereof. Accordingly, various probability distributions can be generated based on the various indices that might be used in quantifying the volatility of any of these portions or combinations of project components or projects. In accordance with an aspect of the present disclosure, indices can be assigned individual weightings that can be used to develop an overall index for the weighted combination of the underlying indices. Such a weighted index can be applicable to portions or combinations of project components or projects to quantify a desired element of the overall project or projects for the purposes of developing an insurance product to provide coverage for desired value volatility over a given time frame.

In addition to, or as an alternative, probability distributions can be weighted to obtain probabilities that reflect value changes for various project components. The weighted probabilities of changes can be combined to obtain an overall probability of change for a project. An insurance product can be created for the desired overall probability of change for the project, which can also consist of a number of individual insurance products that are grouped together.

According to an aspect of the present disclosure, a mechanism is provided for allocating project cost escalation from project participants and to an insurance entity. The vehicle do so is through: (i) the application of cost escalation indices that track price movements for underlying assets, (ii) the creation of either a captive insurance entity or direct placement product that enables the potential escalation to be marketed to insurance and reinsurance underwriters, and (iii) the purchase of an insurance policy that transfers the potential escalation to the underwriter for some premium. The cost escalation indices act as both the mechanism for cost escalation calculation as well as a historical index for which the insurance entity may assess the likelihood of value escalation associated with the project.

The project participants may access the insurance entities either through a captive insurance company (which is, in essence, a wholly owned insurance company of the project or of one of the project stakeholders) or through the means of a direct placement (where the company may approach a syndicate such as Lloyds of London to individually sell the potential value escalation). Both insurance vehicles have pros and cons that would be for the project stakeholders to decide which meets their needs best. The insurance policy then acts as a transfer tool that allocates a portion of the responsibility of the cost escalation to the insurance entity in exchange for some remuneration. As a result, the project stakeholders are able to allocate project cost escalation to an outside entity.

Applications for the presently disclosed systems and methods may be multi-pronged. For instance, should the contractor be the stakeholder engaging in this type of financial transfer, they are better able to refine their project cost estimates as volatility or price uncertainty has been removed from the consideration. In certain cases, the contractor may even be able to fix price projects that were, otherwise, open to price adjustments throughout construction. And the contractor should be able to reduce the contingency held on the project to account for cost escalation being borne by the insurance entity.

In the case of the project sponsor or developer, the present disclosure provides them with considerable financial flexibility. In certain cases, projects that are being primarily financed through the issuance of debt have had difficulty securing favorable ratings (if they can secure ratings at all) on the project bonds. Of concern is the unmitigated exposure the project has to hyper-inflation of materials and labor wages. The present disclosure effectively caps that exposure to the project, enabling the project to get better financing rates and leverage into the project. The present disclosure also lowers the need for contingency and manager's reserve, enabling the project sponsor or developer to better negotiate pricing with contractors. And the present disclosure helps to ensure that regulated projects, such as in the electric or gas utility industry, do not have to go back to regulators in order to ask for more money to complete the project, enhancing the corporate brand and ensuring that utility ratepayers obtain a long term benefit.

### BRIEF DESCRIPTION OF THE SEVERAL VIEWS OF THE DRAWINGS

The present disclosure is described below in detail, with reference to the accompanying drawings, in which:

FIG. 1 is a timeline showing project components in an overall project timeline;

FIG. 2 is a listing of index data and calculations in accordance with an exemplary embodiment of the present disclosure;

FIG. 3 is a block diagram illustrating the use of weighted indexes in accordance with an exemplary embodiment of the present disclosure;

FIG. 4 is a histogram showing probability distribution according to an exemplary embodiment of the present disclosure;

FIG. 5 is a chart illustrating probabilities for percentage changes in accordance with an exemplary embodiment of the present disclosure;

FIG. 6 is a chart illustrating probabilities for various percentage changes in accordance with an exemplary embodiment of the present disclosure;

FIG. 7 is a weighted probability exposure chart in accordance with an exemplary embodiment of the present disclosure;

FIG. 8 is a block diagram illustrating an calculation of cost probability as determined using a number of cost probability intervals;

FIG. 9, consisting of FIGS. 9A and 9B, is a flow chart illustrating a process for using an index to determine the contents of an insurance product for value escalation; and

FIG. 10 is a flow chart illustrating a claim process for recovery under an insurance product in accordance with an exemplary embodiment of the present disclosure.

### DETAILED DESCRIPTION

The present disclosure provides a mechanism for allocating project value escalation volatility from project participants to an insurance entity. According to an exemplary embodiment, value escalation indices that track movements in the value of underlying assets are used in conjunction with an insurance product that provides coverage for unexpected changes in the value of the underlying assets.

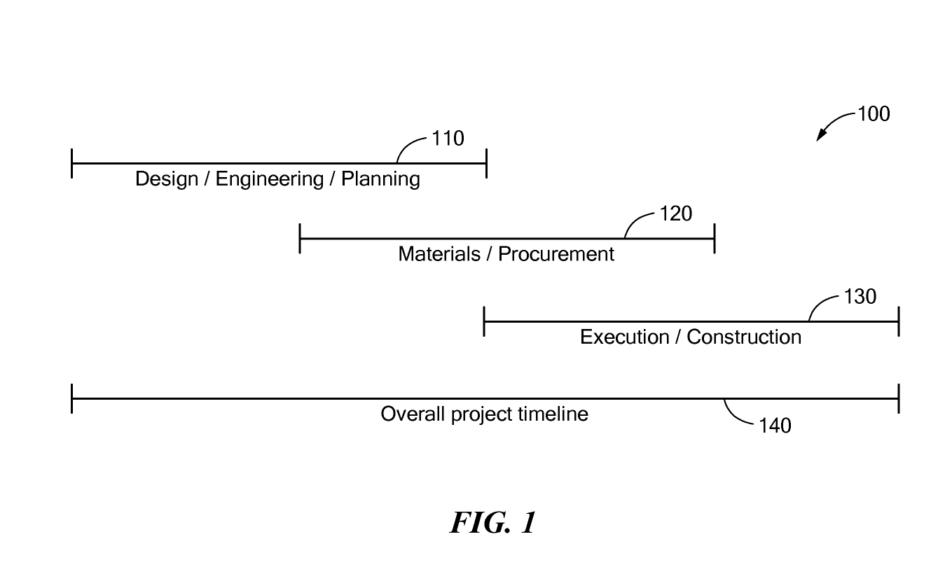

Referring now to FIG. 1, a simplified timeline 100 is illustrated as showing several different stages of an overall project. Timeline 100 includes timeline 110 for design, engineering and/or planning, while timeline 120 illustrates a timeline for materials/procurement and timeline 130 illustrates a timeline for execution/construction. The sum of the timelines 110, 120 and 130 produces the overall project timeline 140.

At the outset of the project, design, engineering and planning takes place as shown with timeline 110 leading the other timelines and coinciding with the beginning of the overall project timeline 140. As the project moves into the physical stage, materials are purchased and services are procured in anticipation of the beginning of actual construction of the project, as illustrated with timeline 120 beginning midway through timeline 110. While timelines 110, 120 and 130 are shown overlapping, they can be extended or reduced as needed for the particular project at hand, and can be non-overlapping, overlapping or coextensive with each other or timeline 140.

As materials are purchased and/or services procured for implementation of the project, construction of the project can begin, as shown by timeline 130 overlapping timeline 120. Although timeline 130 has an endpoint that coincides with the endpoint of timeline 140, indicating project completion, that need not coincide, since other project aspects can be implemented in an interval between the ends of timeline 130 and timeline 140. For example, maintenance, repair or equipment run-in can be considered part of the project that extends beyond execution/construction of the project. During any of the stages of the project illustrated in timeline 100, the present disclosure can be used to assess volatility in the value of a given project component, and an insurance product can be produced and purchased to cover the anticipated volatility in the value of the project component. In addition, the present disclosure can be implemented to produce an insurance product for the overall project that provides coverage for volatility of value of any desired project components in combination.

In accordance with an exemplary embodiment of the present disclosure, one or more indexes are selected for assessing the value of a desired project component. The selected index or indices are chosen to closely approximate the performance of the value of the associated project component. For example, a project component may consist of concrete, for which a producer price index (PPI) exists, for which data is reported on a monthly basis. The index data, produced by the United States Department of Labor, Bureau of Labor Statistics, for example, provides a measure of price variation on a monthly basis. A number of different indices may be used to arrive at a single synthetic concrete index, such as by combining indexes related to non-metallic mineral products, concrete ingredients and related products, construction sand/gravel/crushed stone, crushed and broken stone, and cement indexes, as examples. Since indexes on each of the above items are available for a 24 month period with monthly data, they can each be analyzed to determine where the greatest variation and volatility exists. Those indices with the greatest variation and volatility can be more heavily weighted and combined with other indices to produce a single overall index for concrete, for example. In addition, other concrete indices are provided by other agencies or sources that can be used directly to indicate the historical price fluctuation in concrete over monthly periods.

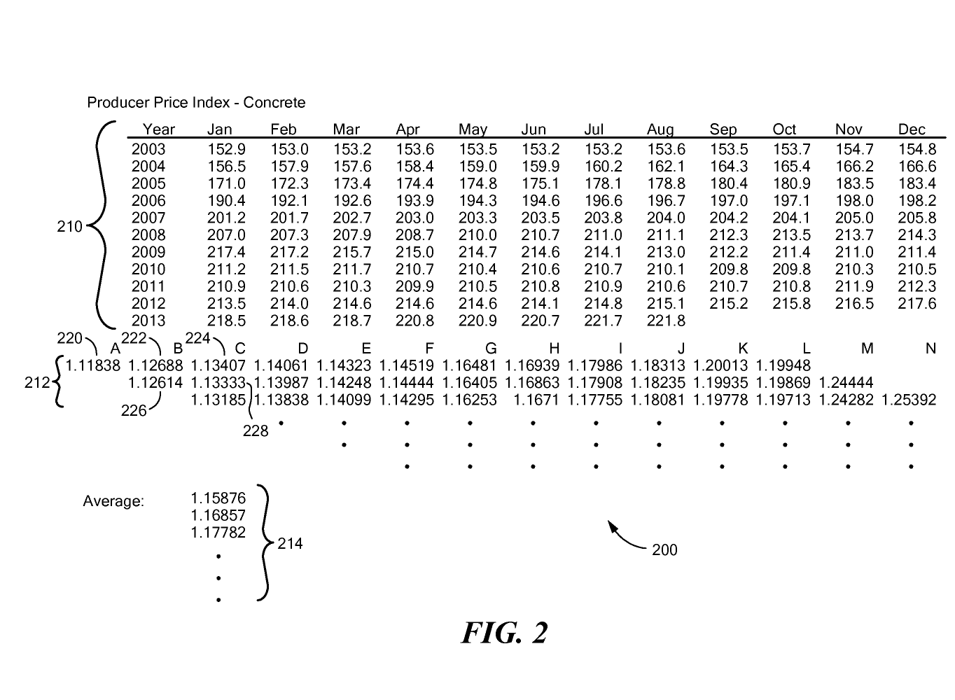

Referring now to FIG. 2, a listing 200 of index data is provided. Listing 200 provides index data that is used to calculate a percentage change over a 24 month period for the underlying project component, which in this example is concrete products. This particular index is provided by the United States Department of Labor, Bureau of Labor Statistics, and has data that is provided on a monthly basis. The percentage change is calculated based on a previous 24 month period for the given entry in listing 200 to determine the historical variation and volatility of the index over that period of time. The period of 24 months is selected based on the expected length of time for the project component associated with concrete products. Although this example provides for a project component that is 24 months in deration, any type of period length can be selected for processing the index data. In addition, other project components or an overall project may be evaluated on an arbitrary period of time, with arbitrary intervals of data, as long as suitable indices with a suitable amount of historical data are available. Once the percentage change is determined, a histogram or probability distribution can be created to illustrate the percentage change and probability in a graphic form.

In FIG. 2, an index listing 210 illustrates index data for concrete prices over an approximately ten year period of time, reported on a monthly basis. The index data provided in listing 210 is used to create percentage changes related to a 24 month period of time, which is the time frame for the project component in the example. A listing 212 is created from listing 210 that represents percentage changes over a 24 month period of time for the data. As an example of a calculation of the percentage change, element 220 in column A of listing 212 is calculated by dividing the January 2005 index value by the January 2003 index value. Likewise, element 222 in column B of listing 212 is obtained by dividing the February 2005 index value by the January 2003 index value. Likewise, element 224 in column C is obtained by dividing the March 2005 index value by the January 2003 index value. The remainder of the first row of listing 212 is calculated similarly.

Element 226 in the second row of column B of listing 212 is calculated by shifting the denominator of the operation by one data period. For example, element 226 is calculated by dividing the February 2005 index value by the February 2003 index value. Element 228 in the second row of column C is calculated by dividing the March 2005 index value by the February 2003 index value. The remainder of the entries in the second row of listing 212 are calculated similarly. In this way, listing 212 represents percentage change values that are related to a 24 month period of time, based on dividing each monthly entry of listing 212 by a base index value that occurred at least 24 months previously.

Listing 212 has 12 entries for each row, which represents 12 percentage change values that are calculated based on the index values of listing 210 in the manner described above. Data points for a final set of percentage change values are obtained by averaging the contents of each row of listing 212, as indicated in listing 214. Each of the entries in listing 214 thus represent an average of a row of listing 212, which is related to 24 month index value changes calculated on a 12 month basis for concrete. It should be understood that any type of period could be used to calculate the percentage change values in listing 212, and the use of a 24 month period is arbitrary with respect to the chosen project component. Similarly, any number of percentage change values can be calculated for listing 212, with the 12 calculated values being arbitrary for the present example.

The calculations performed to obtain the entries in listing 214 assumes a consistent monthly procurement. Such an assumption permits a direct average calculation to be performed on the 12 percentage change values calculated in relation to a 24 month period of time. If the procurement is not consistent on a monthly basis, the monthly volatility can be mapped to the procurement distribution. For example, if ten percent (10%) of the procurement occurs in the first month, and ninety percent (90%) of the procurement occurs in the twelfth month, each of the monthly percentage change values in listing 212 can be weighted in accordance with their respective percentages. Thus, element 220 in column A of listing 212 can be multiplied by ten percent (10%), and the element in column L of the first row of listing 212 can be multiplied by 90 percent (90%). Each of the intervening entries in the first row of listing 212 can be multiplied by zero percent (0%), resulting in a weighted average escalation calculation that would be controlled by the first and last elements of the first row of listing 212, weighted at 10% and 90%, respectively.

Such a weighted average calculation helps to increase the sensitivity of the escalation costs to the index in accordance with the procurement distribution. In addition, the ultimate insurance product can be viewed as a combination of an insurance product for the first month and an insurance product for the twelfth month, with the weighting of the percentage increases being used as a mathematical mechanism for translation of the two insurance probabilities into a single insurance probability.

With respect to the average values contained in listing 214, they reflect the percentage change of the index over the chosen period of time, i.e., 24 months. Thus, the initial entry in listing 214 represents an approximate 16% increase on average of index values over the previous 24 month period, while the second entry in listing 214 represents approximately a 17% increase in index values over the prior 24 month period. The values obtained in listing 214 are used to determine a probability distribution of percentage change for the project component.

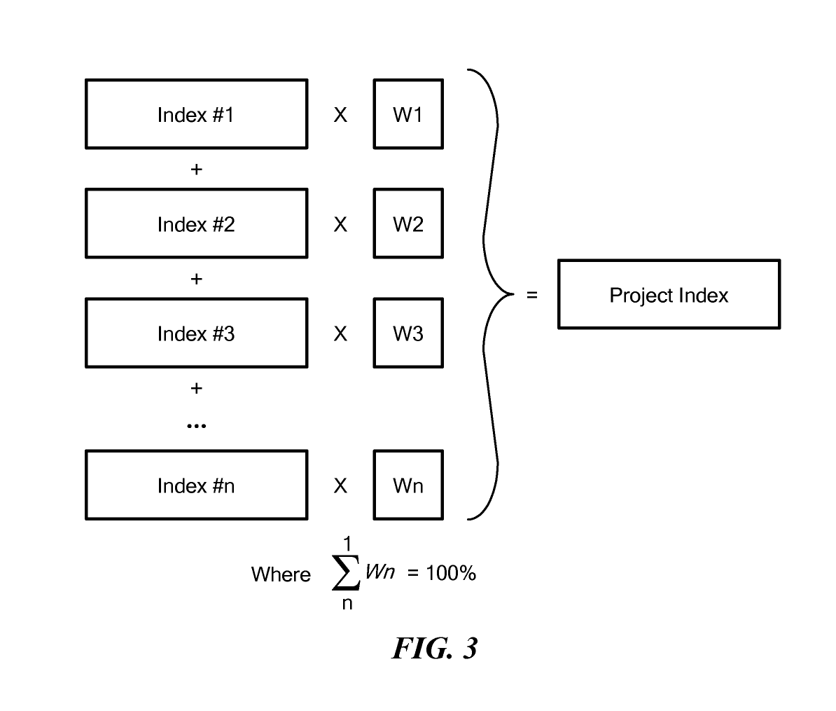

In addition, or alternatively, further sets of percentage change values can be calculated as a combination of underlying, potentially weighted index values. Referring to FIG. 3, a diagram for combining various indices that are variously weighted is illustrated. Each underlying index is assigned a weight such that the weights add up to 100% to obtain a normalized project index. As illustrated in FIG. 3, the various indices for the different project components can also be assigned various weights and combined to obtain an overall project index. The project sponsor can choose which project components and associated indices that are of most significance for the overall project. It should be understood that each project component can also be assigned combinations of weighted indices in the same way that the project illustrated in FIG. 3 is assigned a number of weighted indices. It should also be understood that each project component can be associated with a single index, which is then used to form a probability distribution, which can be weighted and combined with other probability distributions to form an overall project probability distribution. Accordingly, various combinations of indices, weighted indices, project components and probability distributions can be used to arrive at data that represents an overall project.

It should also be understood that although the above-described calculations are based on percentage changes, the present disclosure is not to be sole limited. Other types of calculations can be performed to determine or estimate escalation value changes for a given project component or overall project.

The underlying indices of the various project components can be used to create one or more indices that are sufficiently representative of the project component or overall project so as to be useful in quantifying variation and volatility. The estimated escalation values of the project component or overall project can be used to calculate a probability distribution that can be used to obtain an insurance product for coverage of the volatility of the given project components or overall project. It should be further understood that numerous indices are available for assessing value variation and volatility of any given project component, so that it is generally possible to obtain an index that generally reflects the variation and volatility of a given project component value. The sources of such indices are also varied, ranging from the government to private industry to industry trade groups and so forth. It is generally understood that an index that approximates the variation and volatility in value of a project component can be obtained, generated or combined with other index information, resulting in a useful index for the value of the project component.

In some instances, the time periods for reporting data for a given index is significantly different among indices used to synthesize a project component value index. For example, an index that may relate to labor salaries may be updated on a yearly basis, while an index related to steel products may be updated on a monthly basis. If two such indices are combined to form a single synthetic index related to the price of steel and the changes in labor salaries, the period for the index data points for the synthetic index would be chosen to be the longer of the two reporting periods from the different indices. In this example, such a synthetic index would be provided with data updates on a yearly basis. If a different period for data reporting is provided, such as the monthly period for reporting in accordance with the steel index, the volatility in the value of the labor salary index would be lost, since there would be no change in the labor salary index over each monthly period. Such a loss of volatility would make the quantification of value variation and volatility significantly less accurate. Accordingly, for production of a synthetic index where the underlying indices have mismatched periods for reporting data, the longer period of time is selected to maintain the volatility information for the longer period of reporting for that index. However, it may be possible that the index with the greater reporting period could be broken down into shorter periods for data reporting, through techniques such as interpolation or estimation, which may be assisted by obtaining additional data related to that index that can help guide estimates or interpolation points for the modification to the index. Once the indices are modified to have a same or similar period for data reporting, a synthetic index can be generated that retains the volatility information of the underlying indices.

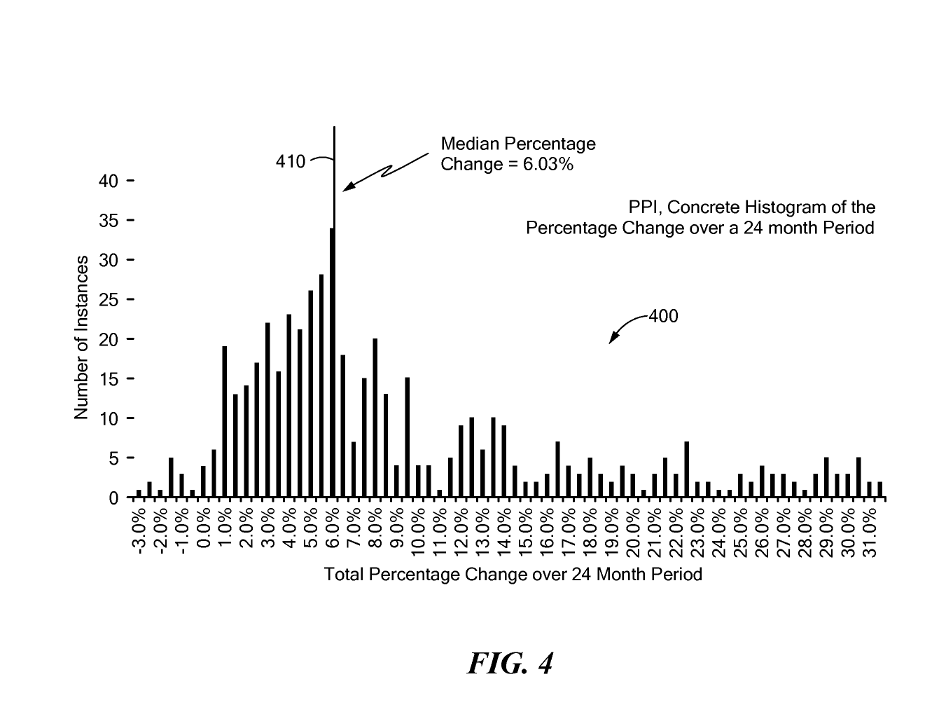

Referring now to FIG. 4, a histogram 400 is provided showing a probability distribution for concrete price changes in accordance with the index data provided from listing 200 in FIG. 2. The probability distribution, or histogram 400, shows the number of instances of percentage changes over a 24 month period, as derived from listing 200 in FIG. 2. As can be seen from histogram 400, there are a number of large percentage change instances reflecting high volatility in a price escalation based on the historical data for concrete prices. Due to the long “tail” of histogram 400, a project sponsor may be justifiably concerned that an amount budgeted for the purchase of concrete, even given a generous buffer, has a significant probability of being less than required due to increased costs over a projected amount during the 24 month period of the project component. It is this probability that the present disclosure seeks to quantify, so that the project sponsor can make informed decisions about seeking insurance coverage changes in value that have problematic chances of occurrence.

One approach to determining a quantification of the probability of value change is by determining a median probability for value change. By calculating the number of instances in conjunction with the respective percentage change over a 24 month period, a median probability for percentage change can be determined. In histogram 400, a median probability 410 of the percentage change over a 24 month period is shown as occurring at approximately 6.03%. With median probability 410, the project sponsor can expect a 50-50 chance of seeing an escalation in costs for concrete of approximately 6.03% over the 24 month period that the project component of concrete is being used. If a project manager were to enter into an agreement for supply of concrete that included escalation terms, the escalation term may be set at 6% to approximate the median percentage change expected over the course of the 24 period for the concrete project component. The use of the escalation term according to the probabilities mentioned above can be used by any of the participating parties in the project component, including the project manager, vendor, contractor, or whichever party is agreed upon to be responsible for escalation costs with regard to concrete over the life cycle of the project component.

The median probability for percentage change is a 50-50 chance of the price escalating by 6% over the course of the project component. It is likely, however, that the responsible party would be more interested in the volatility of the price changes for concrete over the project component life cycle. For example, as illustrated in histogram 400, the volatility of the price of concrete can be significantly high, so as to have a major impact on the value of the project component, and the overall project. Histogram 400 shows a number of instances of relatively high percentage change, tending to indicate a high volatility for the price of concrete over a 24 month period.

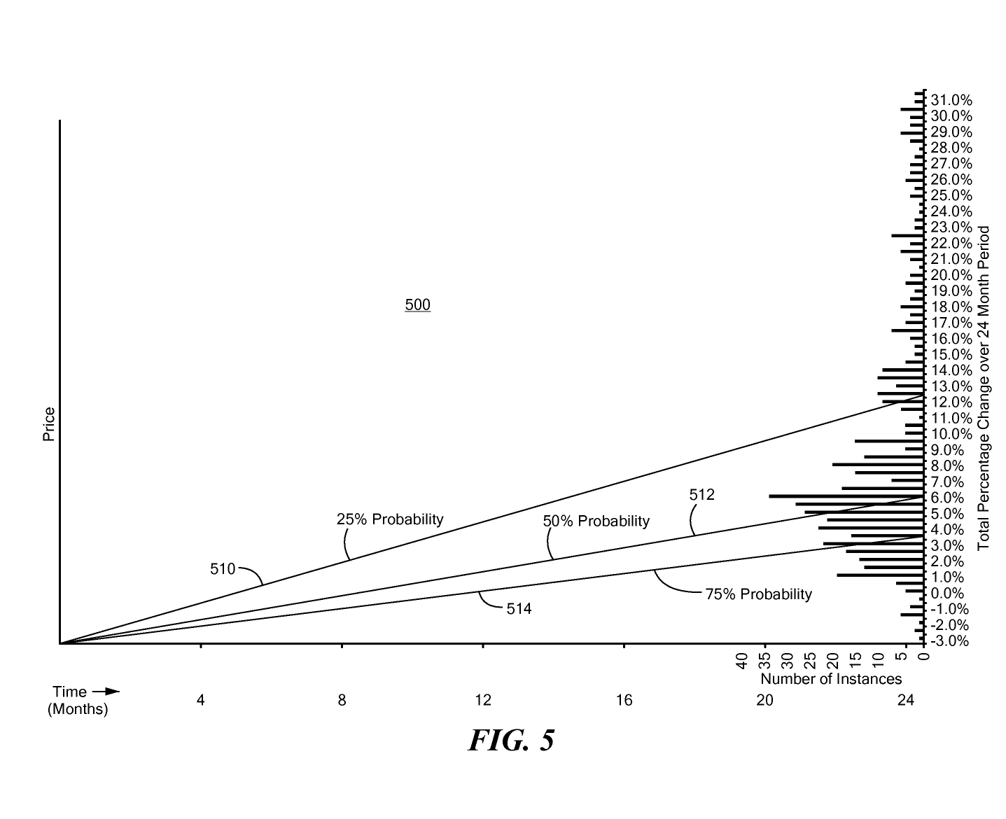

Referring now to FIG. 5, a chart 500 illustrating a feature in accordance with an exemplary embodiment of the present disclosure is illustrated. Chart 500 illustrates a technique for determining the probability of levels of volatility in the price of concrete over a 24 month period. For example, as noted in FIG. 4, the median percentage change of the price of concrete over a 24 month period based on histogram 400 is approximately 6 percent. The median value thus provides a 50% probability of occurrence of that price change. A line 512 illustrates a linear price increase over the 24 month period of the project that is estimated based on the values obtained in histogram 400, which are derived from index 200 provided in FIG. 2. Accordingly, it would be expected by the responsible party that the price of concrete would increase at least about 6% over the course of the 24 month period of the project component with a probability of 50%. Other types of price increases other than linear can be used to approximate the median probability of price change, such as by plotting the median points on a month by month basis based on expected percentage changes that are calculated on a monthly basis in the 24 month period of the project. Accordingly, line 510, 512 and/or 514 need not be straight lines defined by two end points.

Lines 510 and 514 are also shown on chart 500 to illustrate the quartile probabilities for respective percent changes. For example, line 514 describes a linear increase in the price of concrete that has a 75% probability of being reached. Accordingly, there is a 75% probability that the price of concrete will escalate at least 3.5% over the 24 month period of the project component. Likewise, line 510 illustrates a 25% probability of a price increase of at least 12.5%. Accordingly, the probability that the price of concrete will increase by at least 12.5% over the course of the 24 month project component is 25%. As with line 512, lines 510 and 514 can be other than linear, such as by being derived from a locus of points that describe estimated price increases for certain periods of time within the 24 month project component timeframe.

A project sponsor, upon being presented with the information in chart 500, may wish to attempt to protect against a certain amount of volatile price escalation, such as, for example, within the range of probabilities of from 50% to 25%, as indicated by the area between lines 510 and 512 in chart 500. Note that chart 500 is formed in part by using histogram 400 from FIG. 4, and rotating histogram 400 90° counter-clockwise to identify the probability points for price changes over the course of the 24 month project component. Any amount of price change can be the subject of coverage by an insurance product to help the project sponsor contain costs and meet budgetary and other criteria for completing the project. It may be preferable, for example, that coverage be obtained for price increases that may occur above the median probability.

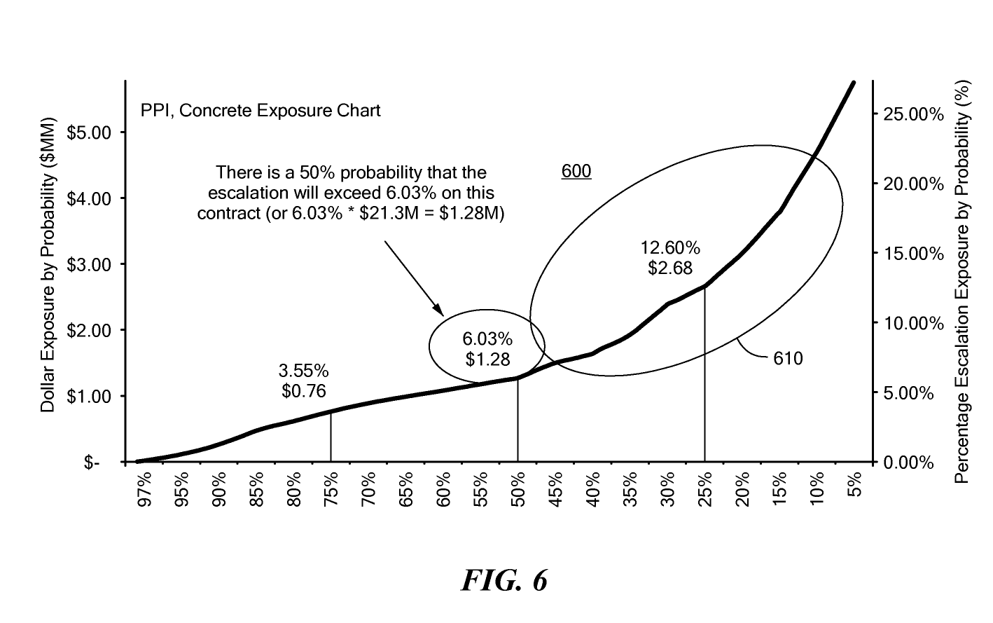

Referring now to FIG. 6 a chart 600 illustrates a plot of probabilities versus a percentage escalation exposure by probability, which also indicates a dollar exposure amount by probability. Chart 600 illustrates the case where the entire cost of the concrete contract is 21.3 million dollars for the 24 months of the project component. Taking the median or 50 percentile probability that there will be a price increase in the costs of concrete, the responsible party could expect to have an even chance of paying an additional 1.28 million dollars over the length of the concrete contract due to price escalation. As discussed previously, this amount can be viewed as the expected variation in concrete prices, and can be set as a term of the concrete delivery contract as the expected increase in costs over the 24 month time frame of the project component. At the 50 percentile mark, it is as likely as not that the responsible party will pay an escalation cost of 1.28 million dollars over the length of the time for the project component. However, chart 600 illustrates a greater concern and problematic issue for the responsible party as the probability decreases, since the percentage escalation in price can increase dramatically. It is in this general area of price escalation volatility indicated as area 610 that the responsible party may seek to insure against with regard to excessive volatility in the price of concrete over the course of the 24 month project component.

For example, chart 600 shows a 25% probability that there will be at least a 12.6% increase in the price of concrete over the course of the 24 month project component. Such a 12.6% increase in the price of concrete over the course of the project translates into a 2.68 million dollar cost increase for the 21.3 million dollar project component. If the responsible party would like to shift the cost and probability of the price escalation to an insurance provider, the data provided by chart 600 can be used to estimate the cost of coverage in an insurance product, along with an attendant insurance premium. For example, chart 600 shows that there is a 97% probability that the price of concrete will escalate above 0% and a 50% probability that the price of concrete will escalate by at least 6.03% over the course of the project component. The responsible party can choose to purchase an insurance product to cover a desired cost escalation probability, for example, the probability that concrete cost will escalate above 50% over the course of the project component. In practice, the insurance coverage available to the responsible party is preferably for at least a 50% probability event, which satisfies an insurance provider's typical desire to insure a “fortuitous event,” meaning that the event is at least as likely as not to happen. Such coverage availability can also serve to help the insurance provider meet underwriting or regulatory compliance demands.

As another practical matter, an insurance provider may wish to provide insurance coverage for value escalation based on the percentage increase, rather than the probability of value escalation. For example, the insurance provider may seek to provide coverage for increases of at least 10% or 15% over a given period of time, as long as the probability of such increases is 50% or greater. The insurance provider would thus seek to have the insured be responsible for retaining some portion of the value escalation percentage. In such a situation, the responsible party would themselves cover value escalation within a retention amount up to the insured percentage increase of 10% or 15%, as the case may be. In any case, the insurance provider and the responsible party seeking coverage would be able to agree on terms of insurance coverage based on the calculated values obtained from the relevant index or indices. The following description uses the 50 percentile probability for the sake of example, and the present disclosure is not to be considered to be limited to such an example, since the presently disclosed systems and methods are applicable for any chosen probability or percentage values.

Using the values that are provided by index 200 (FIG. 2) and histogram 400 (FIG. 4), a weighted probability for price escalation can be determined. For example, between the 50^{th} and 45^{th} percentile probability of percentage increase, the index data includes 29 historical instances. The total number of instances in the data set of the index is 514, so any single instance has a probability of 0.19%. Taking all 29 instances in the 50-45% range, and multiplying their respective dollar amount corresponding to percentage change by their individual probability of occurrence, and summing each of those 29 instances provides the weighted probability of cost exposure for that particular probability range.

For example, if there is a single instance of price increase of 1.28 million dollars, at the 50 percentile mark, which is multiplied by 0.19% probability, the result is $2,432.00 of weighted probability price change for that instance. Performing similar calculations on the instances between the 50% and 45% ranges leads to weighted probability price changes for all 29 instances between the 50% and 45% range. There is thus approximately $70,000.00 of weighted probability expose between the 50% and 45% probability levels for price changes expected for concrete over the 24 month period of the project component.

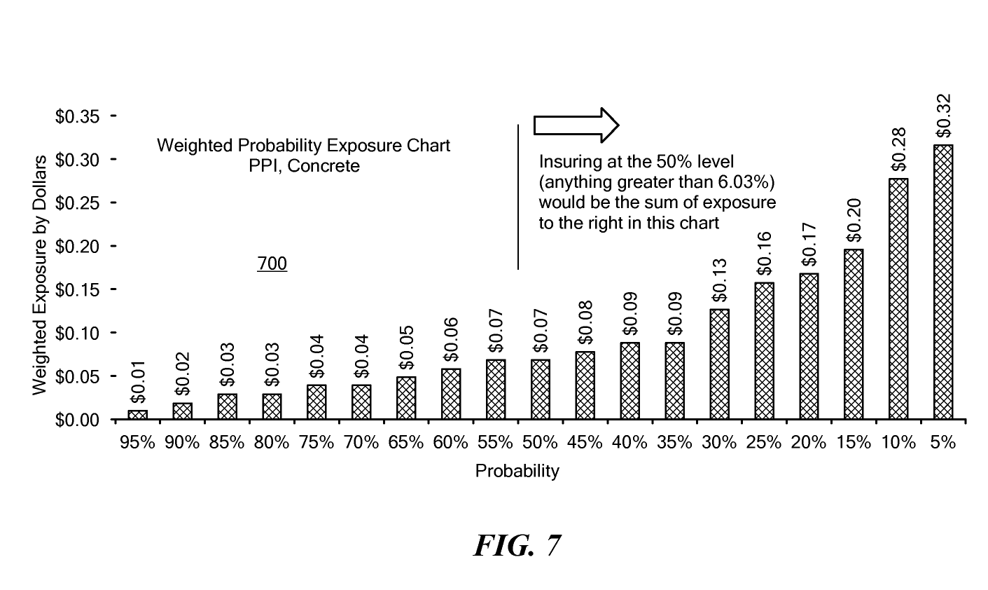

Referring to FIG. 7, a chart 700 of the weighted probability price escalation for the concrete project component is illustrated. As indicated in chart 700, if a responsible party wished to insure against price escalation volatility above the median probability value (50%), the weighted exposure to the right of that level would be summed to obtain the amount of coverage. A responsible party may also choose to seek insurance for an interval of coverage, such as from the median probability to the 24 percentile probability. In such a case, the included weighted exposures from chart 700 would be summed to obtain the coverage amount to be insured by an insurance product.

In practice, an insurance provider would typically seek to adjust premiums in accordance with internal analyses. Given chart 600 (FIG. 6), for example, an insurance provider would consider the probability curve and exposure amounts for the project component and internally determine a premium with which they would feel comfortable. For example, an insurance provider may have specific information or perspective related to cost expectations or forecasts for the concrete market. The insurance provider may wish to include or overlay such information or perspective on the probability of value escalation for the project component to arrive at a premium for an insurance product. For example, an insurance provider may understand the concrete market to have recently changed, and may choose to assign increased weight to the probability of recent concrete pricing. Another insurance provider may project a concrete market slowdown, and determine that certain ranges of probability of price escalation should be less than that which was determined from analyzing the historical index information.

The insurance provider can then determine a “rate online” for the coverage for value escalation of the project component. For example, the responsible party may cover the first 10% of escalation costs, which would equate to a retention amount. The insurance provider covers above the retention amount to the limit, which is where coverage responsibility reverts back to the responsible party as the policy holder. The rate online would be the coverage provided by the insurance provider between the retention amount and the limit.

Often, the total coverage provided by the insurer rate online is broken down into different tranches. For example, suppose the probability of price escalation in the concrete example given above between a 6.03% and a 7.5% increase is much more likely to happen than that of a price escalation in the range of from a 7.5% to a 10% increase. Suppose further that the probability of price escalation in the range of from 10% to 15% is even less likely to happen than an increase in the range of from 7.5% to 10%. In such an instance, the insurance provider may structure the insurance policy to have a premium charge of 35% for the first tranche of between 6.03% and 7.5% price escalation, a premium charge of 25% on the second tranche of between 7.5% and 10% price escalation, and a premium charge of 5% on the third tranche of between 10% and 15% price escalation. These premium charge percentages would be multiplied by the amount of coverage in each tranche to get the total cost of the premium.

The above approach permits the total premium to be weighted with respect to the probability of the insured event. The structure of the insurance product can be viewed as segmenting the exposure of price escalation into three separate insurance products. The first product has a retention of zero and a limit of +1.47% (7.5%-6.03%). The second product has a retention of 1.47% and a limit of +3.97% (10%-6.03%). The third product has a retention of 3.97% and a limit of 5% (15%-10%). Using such an approach, the insurance provider can be flexible in setting premiums and can be responsive to the market and market conditions. The index based approach for determining the probabilities of value escalation according to the present disclosure thus permits the insurance provider to quantify and audit the exposure.

In addition to calculating probabilities for value escalation of single project components, the present disclosure can be used to combine various project components to assess overall project value escalation and the associated probabilities. For example, a responsible party can undertake payment of labor costs for a project that also involves price escalation for concrete. In such an instance, the above described techniques for using indexes to estimate and quantify value escalation volatility, for which an insurance product can be purchased, can be applied to obtain individual insurance premiums for each project component. The insurance premiums can be combined to obtain an overall insurance premium for an insurance product to cover all the desired project components.

Moreover, the various project components can be weighted and combined according to the expectations of the responsible party for value escalation that the project component might contribute to the overall project. For example, materials may be weighted at 60% of the overall project value, while labor is weighted at 35% and financing is weighted at 5%. According to an exemplary embodiment of the present disclosure, each of the indexes used to calculate price escalation and probability are weighted in accordance with their respective weight values. The weight values of the project component indices collectively represent the overall value of the overall project. For example, a materials index could be multiplied by 60%, while a labor index is multiplied by 35% and a financing index is multiplied by 5% to adjust the relative impact of the different value escalations on the overall project value over the course of the project. Each weighted index can be used to determine a desired amount of insurance coverage for the desired probability of value escalation, and the resulting insurance premiums can be combined to obtain an overall insurance premium for the project.

Alternatively, or in addition, the individual weighted indexes can be combined to obtain an overall weighted index. The overall weighted index can then be used to obtain an insurance product premium for the overall project that is sensitive to the different project components. For example, if the cost of materials were to increase and the cost of labor were to decrease, the overall project costs would not increase as much as when the project components are considered alone for an insurance premium. If the individual project components were to be separately assessed for determination of separate insurance premiums, the opportunity to offset the individual price escalations against each other may not be utilized as easily, which may lead to an overall insurance premium that is greater than which might otherwise be possible.

Another option for using weighted indices is to vary the weighting of the index to obtain a constant percentage portion for project component value in the overall project value. Thus, if the cost of materials increases in greater proportion to the increase in value of labor or financing, the weighting applied to the materials index can be adjusted so that the impact of material value remains at 60% in the overall project value during the course of the project. The weights themselves can vary or be static according to the responsible party's desire, which may be influenced by the particular characteristics of the project component under consideration. For example, some project components may be more sensitive than others to geopolitical influences, which can be reflected in changes to the weighting of the project component. In general, weighting is established based on expectations of value sensitivity of the project component with respect to the overall project.

According to an exemplary embodiment of the present disclosure, the responsible party can choose to obtain insurance coverage for a limited range of value escalation and probability for a given project component or combinations of project components. For example, if the responsible party wishes to absorb the median probability price escalation, which can be written into the terms of an EPC contract, then the retention amount for the insurance product is the price escalation at the median probability level, which in the example above was approximately 6% price escalation. The insurance product purchased by the responsible party states this retention value, as well as a limit of insurance coverage. For example, the responsible party may wish to obtain insurance coverage for price escalation between the median probability and the 25% probability level. In such an instance, the retention amount is the 50% probability value escalation amount, while the limit of coverage would be the 25% probability value escalation amount. In the above example, the retention would be approximately 6% of value escalation of the price of concrete, while the limit of coverage would be approximately 12.6% value escalation in the price of concrete. The insurance product would cover value escalation between 6% and 12.6%, with the responsible party taking on the remainder amounts of value escalation volatility. By selecting a range of coverage based on probabilities of value escalation, the insurance premium can be reduced to a value that the responsible party is comfortable with, while still obtaining insurance coverage for a desired amount of value escalation volatility.

The insurance policy that is issued for coverage of value escalation volatility can be structured in a number of ways. For example, a number of different probability distributions or histograms can be calculated for a given project component based on index data for various periods of time. For example, twenty different histograms could be computed for different periods of a given project component, each of which periods have insurance coverage for their anticipated value escalation volatility. The insurance product could be based on sum a number of different periods, such as 6 months, 1 year and/or 1.5 years to get a combination of value escalation volatility for which insurance could be provided on an ongoing basis and adjusted over those periods of time. Alternatively, or in addition, the insurer could obtain a graduated assessment for each particular period of interest over the course of the project component or combinations of project components. Premiums could be calculated for each period of each project component, and then combined to obtain a single number for the insurance product premium. Alternatively, or in addition, a number of index-based probability distributions can be calculated, one or more for each project component. The distributions can then be combined to product an overall project index-based probability distribution that can be used to set a premium for an insurance product for the overall project. Alternatively, or in addition, the insurance product could specify graduated premium payments for each period of time in the project component or combination of project components for which value escalation volatility coverage is provided.

A number of other insurance policy structures can be used or applied in providing coverage for value escalation volatility, some of which may depend on the financing available to the responsible party or secondary markets available to the insurance provider. For example, the responsible party may receive payments or financing for execution of the project component on the basis of completed milestones. Insurance premiums could be structured so that the responsible party makes graduated insurance premium payments at specified periods or milestones over the course of the project component timeframe. Some project components may be sensitive to periodic or seasonal changes in value, which may prompt the responsible party or the insurance provider to obtain insurance premium payments at particular times to meet the needs of the reciprocal characteristics of the project component value. For example, if a project component depends on a growing season, the insurance provider may wish to take positions in related commodity markets to offset the potential pay-out on the insurance policy. Such commodity market positions may be entered at particular times of the year, so that the insurance provider may seek an insurance premium at those times.

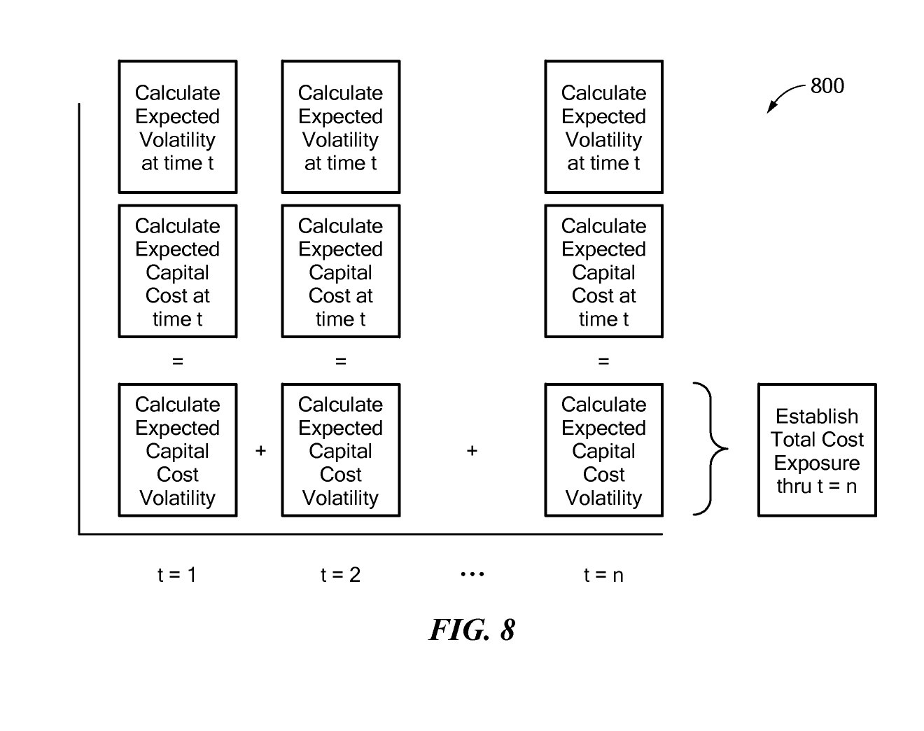

Referring now to FIG. 8, a table 800 illustrates the combination of various time frames for calculated expected cost volatility. For each time frame t=1, t=2, . . . t=N, the expected volatility is calculated. The expected volatility is used to calculate the expected capital cost for the project component at that particular time frame. The expected cost volatility is calculated for that time frame and summed with the expected cost volatility for the other time frames of interest. The resulting summation provides the total cost exposure, or probability of value escalation volatility throughout those time frames.

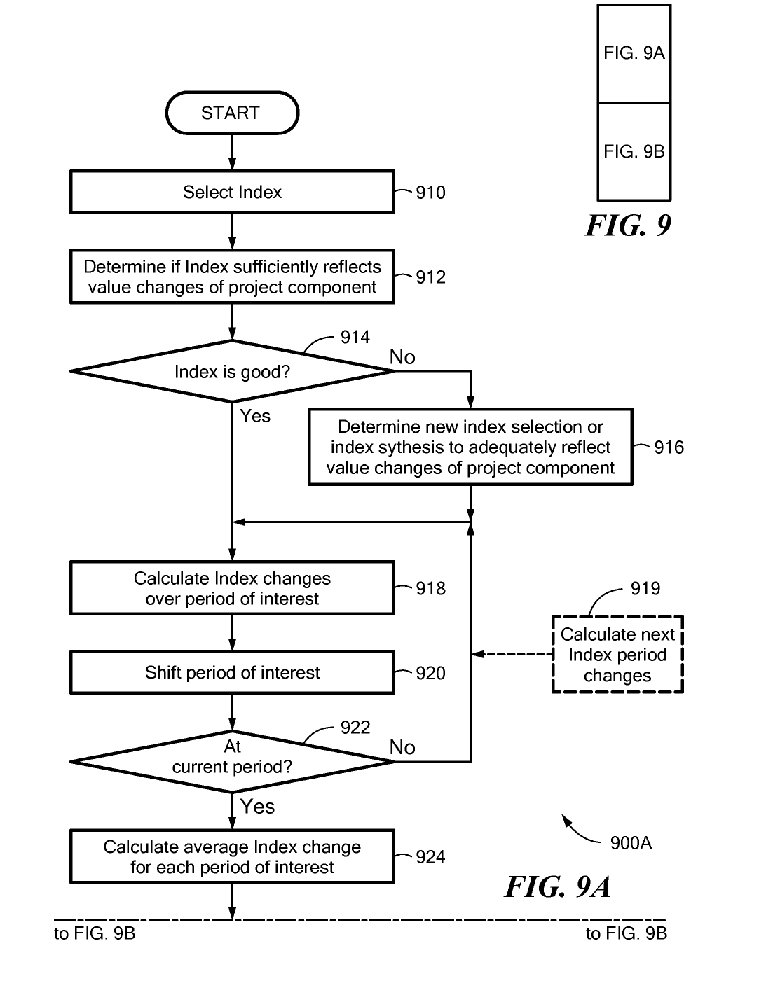

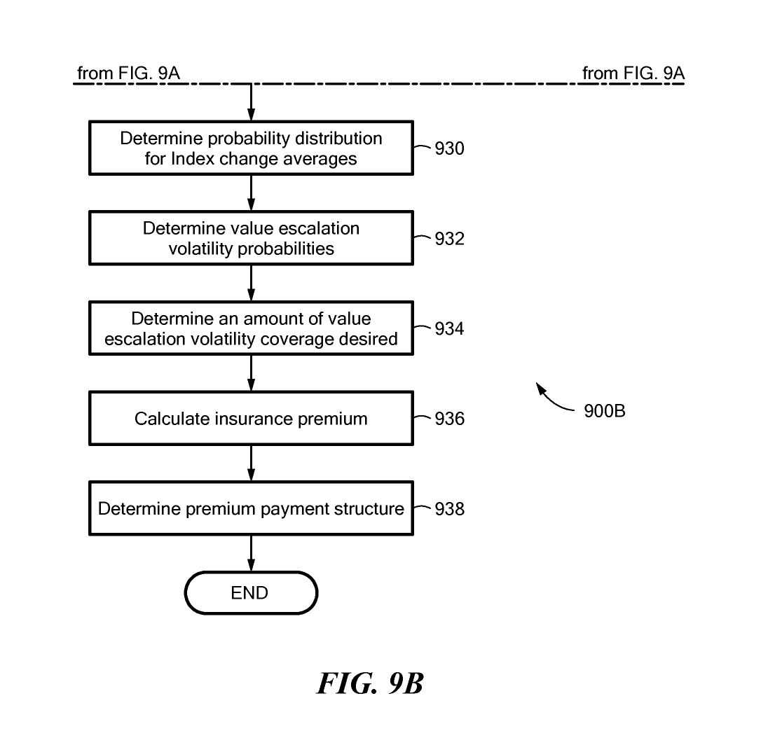

Referring now to FIG. 9, depicated as FIGS. 9A and 9B, a flowchart 900A, 900B, illustrates an exemplary embodiment of a process in accordance with the present disclosure. Flowchart 900A begins with the selection of an index, as depicted in a block 910. An assessment of the index is made to determine if the index sufficiently reflects the desired value changes of the project component that it is to represent, as is illustrated in a block 912. If the index sufficiently represents the project component, index calculations are performed, as illustrated with the Yes branch of a decision block 914. If the index is judged to insufficiently represent the project component, a new index is determined, as indicated by the No branch of decision block 914 being directed to a block 916. Block 916 illustrates the determination of a new index by selection of a new index, or by synthesizing a new index, which may be based on various factors including combinations of indexes and other pertinent data. The newly selected index determined in block 916 is then used for index calculations.

Index changes over a period of interest are calculated using the selected index, as depicted in a block 918. The index calculations are performed according to this exemplary embodiment by choosing a time period representative of the project component time frame that is available from historical index data. Index changes over the selected period of interest are calculated by dividing sequential index values over the span of the selected period of time by the initial index value for that period of time. The calculated result is a percentage change for the index for a series of index values over the selected period of time.

Once the index changes are calculated for the period of interest, a period of interest is shifted, typically by one unit of time in which data for the index is reported, as indicated by a block 920. A decision block 922 determines whether all the desired periods of interest have been processed to calculate index changes. If all periods of interest have not been processed, the next period of interest, as determined by the shift illustrated in block 920, is processed to calculate index changes, as indicated by the No branch of decision block 922 being directed to block 918. This process is illustrated by a comment block 919. If all the periods of interest have been processed, processing continues to calculate average index changes, as indicated by the Yes branch of decision block 922 being directed to a block 924. Block 924 illustrates the calculation of an average index change for each period of interest. For example, taking a series of calculated index changes over a period of time and averaging those index changes for that period of time produces the average index change for that period of interest, as illustrated in block 924.

The average index change for each period of interest is used to determine a probability distribution, as illustrated in a block 930 in flowchart 900B. Once the probability distribution, such as a histogram, is determined, the value escalation volatility probabilities can be determined, as illustrated in a block 932. The determined probabilities are those that indicate the likelihood of certain percentage value changes of the project component over the course of the project component time frame. Once the value escalation volatility probabilities are determined, a responsible party can then determine the amount of value escalation volatility coverage that is desired, as is illustrated in a block 934. Once the responsible party determines an amount of coverage that is desired for the value escalation volatility, and insurance product can be provided with an associated premium that is calculated based on the amount of coverage desired, as is illustrated in a block 936. According to an optional feature of the present disclosure, the responsible party and the insurance provider can then determine a premium payment structure for payment of the premium and coverage over desired periods of time over the course of the project component time frame, as is illustrated in a block 938.

The process for determining an insurance premium for insurance coverage of value escalation volatility based on a selected index that is illustrated in FIG. 9 can be repeated for other project components associated with a given project or sub-project. In such an instance, each of the selected indexes or insurance premiums for the combination of project components desired to be combined can be weighted in accordance with their relative importance to the overall project. The weighted indices can be combined to obtain an overall index for the project that can be used to determine an insurance premium. Alternatively, or in addition, the weighted insurance premiums can be combined to produce an overall insurance premium for the project.

Insurance providers can undertake the coverage desired in an insurance product for value escalation volatility. One strategy for an insurance provider is to seek to distribute coverage costs by obtaining coverage in the reinsurance market. For example, an insurance provider could seek coverage from a larger insurance entity that provides reinsurance coverage, such as a Lloyds of London. Alternatively, or in addition, a captive insurance company can be created that can provide coverage for an insurance product and that is under the control of an insurance provider or responsible party. Such a captive insurance provider could offset the cost of their insurance product offerings through the reinsurance market or other financial vehicles, including derivative products such as commodity market options or futures. Typically, insurance providers are much more likely to obtain beneficial arrangements for offsetting the cost of coverage in an insurance product in accordance with their normal business operations. In addition, the structure of the insurance provider can be used to avoid problematic issues for meeting regulatory requirements with regard to the provision of insurance products. For example a responsible party would not be suitable for or desirous of qualifying as an insurance entity, and meeting all of the regulatory requirements for such an entity. Accordingly, the responsible party may not wish to provide its own insurance, and be excluded from the insurance or derivative markets for underwriting a value escalation policy. However, a captive insurance entity that is formed and controlled by the responsible party can essentially be treated as a wholly owned insurance entity for the sake of the project component or a project participant. In any event, the insurance provider undertakes the responsibility for offsetting the coverage provided for value escalation in the project component or overall project as desired.

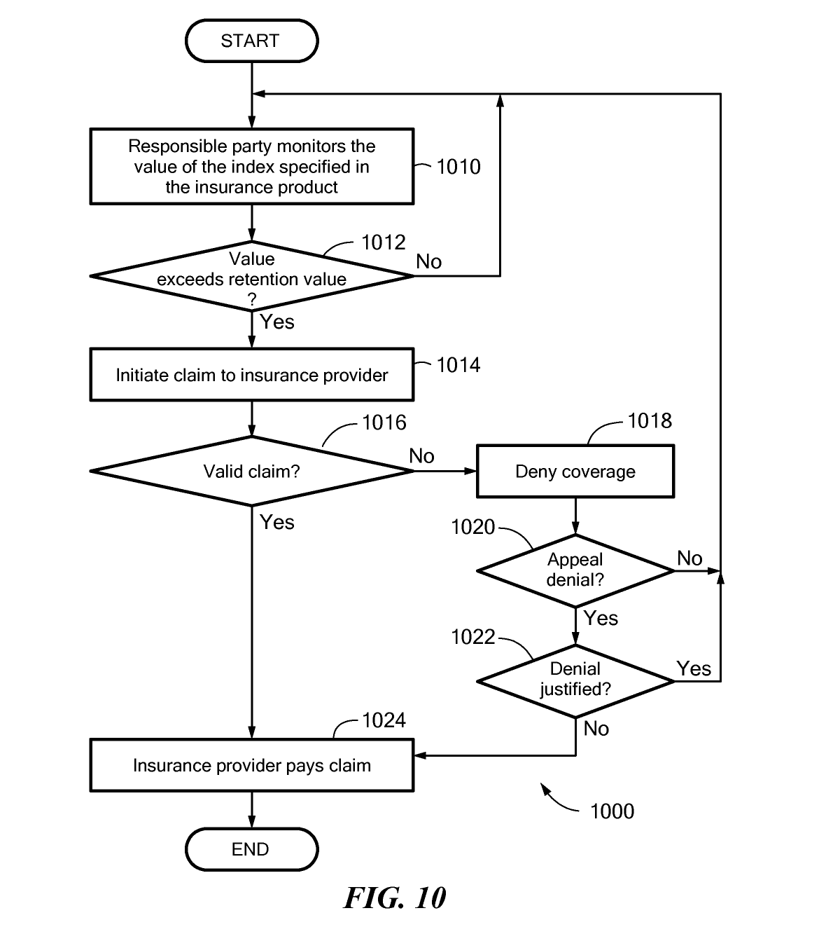

Referring now to FIG. 10, a flow chart 1000 illustrates an exemplary embodiment of operations involved in determining coverage in the case of an insured or “fortuitous” event specified in the insurance policy. Over the course of the project component timeframe or life cycle, the responsible party monitors the value of the index or indices specified in the insurance policy, as depicted in a box 1010. The selected index against which the value of the project component is measured may be written into a contract to which the responsible party is bound. The selected index may alternatively, or in addition, be agreed upon by the responsible party and the insurance provider in the insurance policy specifying coverage for the value escalation volatility for the project component.

The value escalation coverage provided in the insurance product may be stated in a number of ways or formats. For example, the coverage may be stated in terms of the index, so that if the index increases by a specified amount, such as a specified percentage, during the project component life cycle, then insurance coverage is available. As another example, monetary amounts that are directly tied to the selected index may be used. In any case, the insurance policy sets out the terms under which coverage is available based on the selected index or indices.

If the selected index changes, for example, to exceed the retention point stated in the insurance policy, the responsible party may initiate a claim, as indicated by the Yes branch of a decision block 1012 being taken. If the selected index value of the project component does not exceed the retention point specified in the insurance product for coverage of the agreed upon value escalation volatility, the responsible party continues to monitor the index value of the project component for escalation events, as indicated with the No branch of decision block 1012 being directed to block 1010. According to an exemplary embodiment, the insurance product may include terms that state that coverage will be available after the index value exceeds the retention point by a buffer amount. Such a provision allows for fluctuation in the index value with a certain amount of hysteresis to avoid claims being made based on the index crossing the retention point threshold several times, such as may be the case if the index is volatile around the retention point. According to another exemplary embodiment, the insured and insurance provider may set a particular time and/or date for review of the index to see whether a claim can be appropriately made based on the index value at that time and/or date.

If the responsible party decides to initiate a claim to the insurance provider, as indicated in a block 1014, the insurance provider determines if the claim is valid, as depicted in a decision block 1016. The insurance provider may determine if the claim is valid by comparing the value of the selected index against the retention point, which can be used as a threshold for coverage initiation. If the insurance provider determines that the claim is not valid, as indicated by the No branch of decision block 1016, the insurance provider may deny coverage, as depicted in a block 1018. If coverage is denied, the responsible party may appeal the denial, as depicted in a decision block 1020. If the responsible party does not appeal the denial, the value of the index continues to be monitored by the responsible party for a covered event, as indicated by the No branch of decision block 1020 being directed to block 1010. If the responsible party does appeal the denial, as indicated with the Yes branch of decision block 1020, an independent party may be called upon to determine if the denial was justified, as indicated in a decision block 1022 being reached via the Yes branch of decision block 1020.

If it is determined that the denial of coverage was justified, no coverage is provided for the claim and the denial stands, as illustrated by the Yes branch of decision block 1022 being directed to block 1010. If the denial of coverage was not justified, as depicted by the No branch of decision block 1022, the insurance provider pays the claim to cover the value escalation volatility of the project component, as illustrated in a block 1024. Block 1024 is also reached if the insurance provider determines that the claim is valid initially, as depicted by the Yes branch of decision block 1016 being directed to block 1024.

The operations herein depicted and/or described herein are purely exemplary and imply no particular order. Further, the operations can be used in any sequence when appropriate and can be partially used. With the above embodiments in mind, it should be understood that they can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared and otherwise manipulated.

Any of the operations depicted and/or described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The disclosed systems and methods can also be embodied as computer readable code on a computer readable medium. The computer readable medium is any data storage device that can store data, which can be thereafter be read by a computer system. Examples of the computer readable medium include hard drives, read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

The foregoing description has been directed to particular embodiments of this disclosure. It will be apparent, however, that other variations and modifications may be made to the described embodiments, with the attainment of some or all of their advantages. The procedures, processes and/or modules described herein may be implemented in hardware, software, embodied as a computer-readable medium having program instructions, firmware, or a combination thereof. For example, the functions described herein may be performed by a processor executing program instructions out of a memory or other storage device. Therefore, it is the object of the appended claims to cover all such variations and modifications as come within the true spirit and scope of the disclosure.

What is claimed is:

1. A computer implemented method for managing project value escalation, comprising:
determining an index for approximating value changes for the project;
generating a set of value changes from the index;
generating a probability distribution for the value changes; and
generating an insurance product for coverage of selected value change probabilities, wherein the insurance product provides coverage for project value escalation for selected probabilities of value change.

2. The method according to claim 1, further comprising generating the value change as a percent change in the index.

3. The method according to claim 2, further comprising generating a set of percentage changes for each period of the index over a timeframe associated with any duration of the project.

4. The method according to claim 1, further comprising determining the index by combining weighted indices related to the project.

5. The method according to claim 1, further comprising generating a histogram of probabilities of value changes for the set of value changes.

6. The method according to claim 5, further comprising calculating a median probability of value change for the histogram.

7. The method according to claim 6, further comprising selecting a set of value change probabilities for coverage by the insurance product.

8. The method according to claim 1, further comprising designating one or more of a retention value or a limit value for the insurance coverage.

9. The method according to claim 1, further comprising submitting a claim under the insurance product for coverage of value changes specified by the insurance product.

10. The method according to claim 1, further comprising establishing an insurance product premium for coverage specified by the insurance product.

11. A system for managing project value escalation, comprising:
a processor communicatively coupled to a memory to access and execute instructions to:
determine an index for approximating value changes for the project;
generate a set of value changes from the index;
generate a probability distribution for the value changes; and
generate an insurance product for coverage of selected value change probabilities, wherein the insurance product provides coverage for project value escalation for selected probabilities of value change.

12. The system according to claim 11, wherein the processor is further operative to generate the value change as a percent change in the index.

13. The method according to claim 12, wherein the processor is further operative to generate a set of percentage changes for each period of the index over a timeframe associated with any duration of the project.

14. The system according to claim 11, wherein the processor is further operative to determine the index by combining weighted indices related to the project.

15. The system according to claim 11, wherein the processor is further operative to generate a histogram of probabilities of value changes for the set of value changes.

16. The system according to claim 15, wherein the processor is further operative to calculate a median probability of value change for the histogram.

17. The system according to claim 16, wherein the processor is further operative to select a set of value change probabilities for coverage by the insurance product.

18. The system according to claim 11, wherein the processor is further operative to designate one or more of a retention value or a limit value for the insurance coverage.

19. The system according to claim 11, wherein the processor is further operative to submit a claim under the insurance product for coverage of value changes specified by the insurance product.

20. The system according to claim 11, wherein the processor is further operative to establish an insurance product premium for coverage specified by the insurance product.

21. A system for managing project value escalation, comprising:
an index selection engine for displaying and selecting one or more indices;
a histogram generator communicatively coupled to the index selection engine for receiving data related to the one or more indices and generating a histogram of the data; and
a premium calculation engine for determining a premium for insurance coverage of the project value escalation based on the histogram generated by the histogram generator.

22. The system according to claim 21, further comprising:
a weighting mechanism for assigning a weight to each of the one or more indices; and
the premium calculation engine being operative to determine a weighted histogram for each one of the one or more indices in accordance with the assigned weight.

23. The system according to claim 21, further comprising:
an index monitoring unit for monitoring the one or more indices and operative to indicate when an insurance claim can be made for coverage of a project value escalation event.
